(19) United States
(12) Patent Application Publication
(10) Pub. No.: US 2023/0280852 A1
(43) Pub. Date: Sep. 7, 2023

(54) PATTERNED CONFINED AREAS IN A SENSING ARRAY OF TOUCH SENSOR DEVICE

(71) Applicant: Sensel, Inc., Sunnyvale, CA (US)

(72) Inventors: Darren Lochun, Mountain View, CA (US); Ilya Daniel Rosenberg, Mountain view, CA (US)

(21) Appl. No.: 17/684,888

(22) Filed: Mar. 2, 2022

(51) Int. Cl. G06F 3/041; G06F 3/044

(52) U.S. Cl. CPC G06F 3/0412; G06F 3/0446; G06F 3/0448

(57) ABSTRACT

Touch sensor technologies are provided. In some embodiments, a touch sensor device includes an array of conductive members assembled on a first solid surface. The array includes a first conductive member and a second conductive member adjacent to the first conductive member. The touch sensor device also includes a conductive island contiguous to the first conductive member and the second conductive member. The conductive island overlays, at a defined distance from, a third conductive member assembled on a second solid surface opposite the first solid surface. In some cases, the touch sensor device can further include a conductive coupling member coupled to the conductive island at a first end and further coupled to the third conductive member at a second end opposite the first end. The conductive coupling member can be formed from a conductive material.

### BACKGROUND

A touch sensor device can rely on sensing arrays of conductive members to detect touch points where physical contact is made with a touch layer that overlays the sensing arrays. In commonplace configurations, one of the sensing arrays has first transparent conductive members oriented along a first direction, and the other one of the sensing arrays has second transparent conductive members oriented along a second direction that is substantially orthogonal to the first direction. The sensing arrays can be assembled at a defined distance from one another. Thus, overlapping sections of the first conductive members and second conductive members can form a grid of capacitive structures that can be used to sense touch points on the touch layer. Although non-overlapping sections within sense arrays might detract from sensing performance, such sections can provide, among other things, isolation of capacitive coupling of passive and active areas.

The patterning of a planar conductor to form a sensing array can yield the optical appearance and electrical performance of the touch sensor device. However, much remains to be improved in approaches to improve performance of a touch sensor device. Accordingly, improved patterned arrays of conductive members in a touch sensor device may be desired.

### SUMMARY

The following presents a simplified summary of some embodiments of this disclosure in order to provide a basic understanding of one or more of the embodiments. This summary is not an extensive overview of the embodiments described herein. It is intended to neither identify key or critical elements of the embodiments nor delineate any scope of embodiments or the claims. The sole purpose of this Summary is to present some concepts of the embodiments in a simplified form as a prelude to the more detailed description that is presented later.

In an embodiment, the disclosure provides a touch sensor device. The touch sensor device includes an array of conductive members assembled on a first solid surface, the array including a first conductive member and a second conductive member adjacent to the first conductive member. The touch sensor device also includes a conductive island adjacent to the first conductive member and the second conductive member, the conductive island being capacitively coupled to a third conductive member assembled on a second solid surface opposite the first solid surface.

In another embodiment, the disclosure provides another touch sensor device. That touch sensor device includes an array of conductive members assembled on a first solid surface, where the array includes a first conductive member and a second conductive member adjacent to the first conductive member. The touch sensor device also includes a conductive island adjacent to the first conductive member and the second conductive member. The conductive island overlays, at a defined distance from, a third conductive member assembled on a second solid surface opposite the first solid surface. The touch sensor further includes a conductive coupling member attached to the conductive island at a first end and further attached to a third conductive member at a second end opposite the first end. The third conductive member is assembled on a second solid surface opposite the first solid surface.

In yet another embodiment, the disclosure provides a display device that includes a touch sensor device. The touch sensor device includes an array of conductive members assembled on a first solid surface, the array including a first conductive member and a second conductive member adjacent to the first conductive member. The touch sensor device also includes a conductive island adjacent to the first conductive member and the second conductive member. The conductive island overlays, at a defined distance from, a third conductive member assembled on a second solid surface opposite the first solid surface.

Other embodiments and various examples, scenarios and implementations are described in more detail below. The following description and the drawings set forth certain illustrative embodiments of the specification. These embodiments are indicative, however, of but a few of the various ways in which the principles of the specification may be employed. Other advantages and novel elements of the embodiments described will become apparent from the following detailed description of the specification when considered in conjunction with the drawings.

### BRIEF DESCRIPTION OF THE DRAWINGS

The accompanying drawings are an integral part of the disclosure and are incorporated into this specification. The drawings illustrate example of embodiments of the disclosure and, in conjunction with the description and claims, serve to explain various principles and aspects of the disclosure. Some embodiments of this disclosure are described more fully below with reference to the accompanying drawings. However, various aspects of the disclosure can be implemented in many different forms and should not be construed as limited to the implementations set forth herein. Like numbers refer to like elements throughout.

FIG. 1 is a schematic diagram of an arrangement of sense lines and drive lines in a touch sensor device, in accordance with one or more embodiments of this disclosure.

FIG. 2A is a schematic cross-section of an example of a sensing assembly including sense lines and drive lines, in accordance with one or more embodiments of this disclosure.

FIG. 2B is a schematic cross-section of another example of a sensing assembly including sense lines and drive lines, in accordance with one or more embodiments of this disclosure.

FIG. 2C is a schematic cross-section of yet another example of a sensing assembly including sense lines and drive lines, in accordance with one or more embodiments of this disclosure.

FIG. 2D is a schematic cross-section of yet another example of a sensing assembly including sense lines and drive lines, in accordance with one or more embodiments of this disclosure.

FIG. 3A is a schematic cross-section of an example of a display device that includes a sensing assembly having sense lines and drive lines, in accordance with one or more embodiments of this disclosure.

FIG. 3B is a schematic cross-section of another example of a display device that includes a sensing assembly having sense lines and drive lines, in accordance with one or more embodiments of this disclosure.

FIG. 3C is a schematic cross-section of yet another example of a display device that includes a sensing assembly having sense lines and drive lines, in accordance with one or more embodiments of this disclosure.

FIG. 4 illustrates a section of an example array of conductive members (e.g., an array of drive lines), in accordance with one or more embodiments of this disclosure.

FIG. 5A illustrates a section of another example array of conductive members (e.g., an array of sense lines), in accordance with one or more embodiments of this disclosure.

FIG. 5B illustrates a subsection of the section of the example array of conductive members shown in FIG. 5A, the subsection section depicts multiple conductive islands and a portion of adjacent conductive members, in accordance with one or more embodiments of this disclosure.

FIG. 6A illustrates an example of capacitive coupling between a patterned conductive island in a first array of conductive members and a particular conductive member in a second array of conductive members, in accordance with one or more embodiments of this disclosure.

FIG. 6B illustrates a cross-sectional view of the patterned island capacitively coupled to the particular conductive member shown in FIG. 7A.

FIG. 6C is a schematic cross-section of an example of a sensing assembly including sense lines, a drive line, and a conductive island, in accordance with one or more embodiments of this disclosure.

FIG. 6D is a schematic cross-section of another example of sensing assembly including sense lines, a drive line, and a conductive island, in accordance with one or more embodiments of this disclosure.

FIG. 7A illustrates an example of patterned conductive islands placed between adjacent conductive members (e.g., sense lines), in accordance with one or more embodiments of this disclosure.

FIG. 7B illustrates another example of patterned conductive islands placed between adjacent conductive members (e.g., sense lines), in accordance with one or more embodiments of this disclosure.

FIG. 8A illustrates an example of conductive coupling between a patterned island in a first array of conductive members and a particular conductive member in a second array of conductive members, in accordance with one or more embodiments of this disclosure.

FIG. 8B illustrates a cross-sectional view of the patterned island conductively coupled to the particular conductive member shown in FIG. 8A.

FIG. 9 illustrates an example of a display device in accordance with one or more embodiments of this disclosure.

FIG. 10A illustrates an example, non-limiting, schematic representation of a low-density interpolated configuration in accordance with one or more embodiments described herein;

FIG. 10B illustrates an example, non-limiting, schematic representation of a high-density interpolated configuration in accordance with one or more embodiments described herein;

### DETAILED DESCRIPTION

This disclosure recognizes and addresses, in at least some embodiments, the issue of mitigating capacitive coupling among active and inactive conductive members within a sensing array of a touch sensor device. Existing approaches to reducing such a coupling can include the removal of an amount of conductor from a conductor pattern embodying an array of conductive members that forms a sensing layer. Those existing approaches can cause optical artifacts that are readily apparent to an observer. Because the human eye can be quite sensitive to changes in refractive index present when a transparent conductor has been patterned, even minor changes can be readily noticeable. As a result, in some cases, those existing approaches also can include the addition of index matching layers, with the ensuing extra expense in terms of processing resources and time. In other cases, those existing approaches also can include the reduction of thickness (and ensuing increase of resistance) of a conductive layer to be patterned to form an array of conductive members. Such a reduction can directly influence the color density and, thereby, the ability of the human eye to distinguish between transparent conductor areas and non-transparent conductor areas. Further, reduced thickness can limit the conductivity of a conductive member in the array, thus limiting a size and capability of a touch sensor device that includes the array.

Embodiments of this disclosure include touch sensor devices that incorporate confined patterned areas of conductive material in a sensing array having multiple extended conductive members. A confined patterned area of conductive material constitutes a confined conductive member that is part of the array. In this disclosure, such a confined conductive member may be referred to as a conductive island. Conductive islands can be formed between adjacent extended conductive members within the sensing array. In some cases, a chain of conductive islands can be formed between the adjacent extended conductive members. A dielectric region can separate conductive islands from the adjacent conductive members. The dielectric region can be embodied in, or can include, a void or a dielectric layer, either one resulting from the patterning of the conductive islands.

In some embodiments, a touch sensor device includes an array of conductive members assembled on a first solid surface. The array includes a first conductive member and a second conductive member adjacent to the first conductive member. The touch sensor device also includes a conductive island adjacent to the first conductive member and the second conductive member. The conductive island overlays, at a defined distance from, a third conductive member assembled on a second solid surface opposite the first solid surface. In some cases, the touch sensor device can further include a conductive coupling member coupled to the conductive island at a first end and further coupled to the third conductive member at a second end opposite the first end. The conductive coupling member can be formed from a conductive material.

By incorporating conductive islands within a sensing array, embodiments of this disclosure can self-isolate the layer containing the sensing array and, as a result, can prevent cross contamination of signal and improve touch performance. As such, embodiments of the disclosure provide several improvements over existing technologies to form sensing arrays. As an example, having small areas of isolated conductive material in the embodiments disclosed herein can reduce undesirable capacitance between sense layer and drive layer of a touch sensor device. In addition, having such areas can prevent inadvertent changes in electrical properties within one or both of those layers. As another example, by creating conductive islands in the patterned conductive layer that forms a sensing array can reduce, or even eliminate, the need to remove conductive material in order to prevent detrimental inter-layer or intra-layer electrical interactions. Consequently, embodiments of this disclosure can avoid the need for index matching layers not only because removal of conductive material becomes unnecessary, but also because the conductive islands can serve as effective index-matching layer that hides isolated low resistance conductor areas.

Further, in embodiments in which a touch sensor device is embodied in a printed circuit board assembly (PCBA), the amount of copper present in the printed circuit board (PCB) can affect the operation of the touch sensor device. Without intending to be bound by design considerations, in those embodiments, it would be desirable to preserve as much copper on the PCB as possible in order to reduce processing costs (e.g., time to remove copper) and to ensure planarity (e.g., avoid warpage) of the PCB. Accordingly, as yet another example advantage, incorporating conductive islands can be accomplished without significant processing costs and can cause minimal warpage while providing improved sensor performance.

As still another example, creating conductive islands in the sense layer, for example, can improve sensitivity be enabling preferential capacitive coupling.

The principles of this disclosure also can be applied to any type of touch-sensing architecture where electrical isolation of isolated conductive islands could be beneficial.

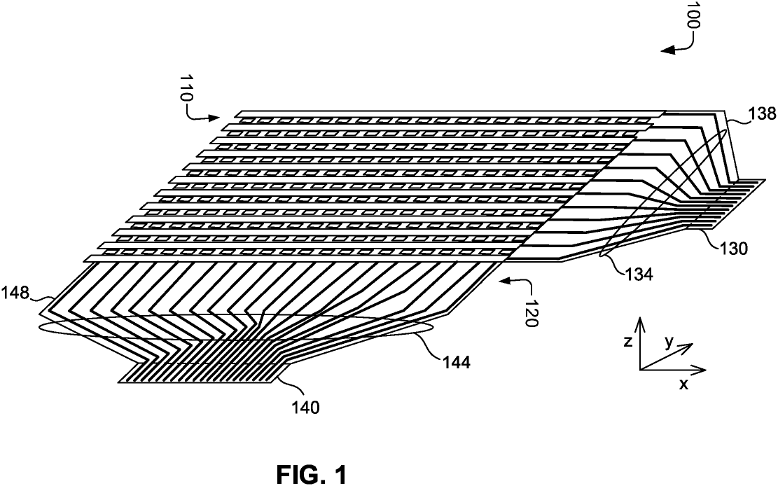

With reference to the drawings, FIG. 1 is a schematic diagram 100 of an arrangement of sense lines 110 and drive lines 120 within in a touch sensor, in accordance with one or more embodiments of this disclosure. The sense lines 110 are substantially contained in a first plane and can be substantially parallel to one another along a first direction (denoted as x in FIG. 1 for the sake of nomenclature). The sense lines 110 form a planar structure that is periodic along a second direction orthogonal to the first direction and has a defined pitch a (a real number in units of length) along the second direction. The defined pitch a has a magnitude in a range from about 500 µm to about 5 mm. In one example, a is equal to 1 mm. In some embodiments, each one of the sense lines 110 is formed from a material that is conductive and has defined optical properties. The material can be transparent, translucent, or opaque. Such a material can be a transparent conductive oxide (TCO), a transparent conductive polymer, or a non-transparent conductive polymer, for example. Numerous conductive polymers can be used to form a conductive member that embodies a sense line. Examples of such conductive polymers include the following: poly(fluorene)s, polyphenylenes, polypyrenes; polyazulenes; polynaphthalenes; poly(pyrrole)s (PPY); polycarbazoles; polyindoles; polyazepines; polyanilines (PANI); poly(thiophene)s (PT); poly(3,4-ethylenedioxythiophene) (PEDOT); poly(p-phenylene sulfide) (PPS); oly(acetylene)s (PAC); poly(p-phenylene vinylene) (PPV).

In other embodiments, each one of the sense lines 110 can be embodied in a metal nanowire or a carbon nanotube (or bud). The metal nanowire can be embodied in a silver nanowire, a gold nanowire, or a platinum nanowire, or a metal nanowire formed from another noble metal. The metal nanowire also can be formed from a non-noble metal, such as a transition metal or a simple metal, in some cases. In still other embodiments, the sense lines 110 can embody a periodic structure along a particular direction, where the structure is formed by patterning a conductive material (such as a metal thin film) or sputtering thin elongated segments of a metal or a combination of metals (e.g., a metal alloy or a co-deposited heterostructure) on a solid surface of a substrate. The substrate can be embodied in a printed circuit board (PCB) in some cases. Here, patterning can include an additive process or a subtractive process depending on the type of conductive material used to form the sense lines 110.

The drive lines 120 are substantially contained in a second plane and can be substantially parallel to one another along a second direction (denoted as y in FIG. 1, for the sake of nomenclature). The second plane and first plane are parallel to one another and are separated by a defined distance (e.g., 10 µm, 50 µm, 100 µm, 500 µm, 1 mm, 2 mm, or 5 mm, for example). The second direction is orthogonal to the first direction. The drive lines 120 also form a planar structure having a defined pitch b (a real number in units of length) along a direction that is orthogonal to the second direction. In some cases, the defined pitch b is equal to the pitch a. The defined pitch b has a magnitude in a range from about 500 µm to about 5 mm. In one example, the defined pitch b is equal to 1 mm. In some embodiments, each one of the drive lines 120 is formed from a material that is conductive and has defined optical properties. The material can be transparent, translucent, or opaque. Such a material can be a TCO, a transparent conductive polymer, or a non-transparent conductive polymer, for example. Numerous conductive polymers can be used to form a conductive member that embodies a drive line. Example of such conductive polymers include the following: poly(fluorene)s, polyphenylenes, polypyrenes; polyazulenes; polynaphthalenes; poly(pyrrole)s (PPY); polycarbazoles; polyindoles; polyazepines; polyanilines (PANI); poly(thiophene)s (PT); poly(3,4-ethylenedioxythiophene) (PEDOT); poly(p-phenylene sulfide) (PPS); oly(acetylene)s (PAC); poly(p-phenylene vinylene) (PPV). In some embodiments, the material that forms the drive lines 120 can be the same as the material that forms the sense lines 110. In other embodiments, the material that forms the drive lines 120 can be different from the material that forms the sense lines 110.

In other embodiments, each one of the drive lines 110 can be embodied in a metal nanowire or a carbon nanotube (or bud). The metal nanowire can be embodied in a silver nanowire, a gold nanowire, or a platinum nanowire, or a metal nanowire formed from another noble metal. The metal nanowire also can be formed from a non-noble metal, such as a transition metal or a simple metal, in some cases. In still other embodiments, the drive lines 110 can embody a periodic structure along a particular direction, where the structure is formed by patterning a conductive material (such as a metal thin film) or sputtering thin elongated segments of a metal or a combination of metals (e.g., a metal alloy or a co-deposited heterostructure) on a solid surface of a substrate. The substrate can be embodied in a PCB board in some cases. Again, patterning can include an additive process or a subtractive process depending on the type of conductive material used to form the drive lines 120.

It is noted that the array of sense lines 110 and the array of drive lines 120 need not be assembled in a substantially planar structure. In some embodiments, each one of those arrays can be assembled on a curved surface. In those embodiments, a distance separating adjacent conductive members (e.g., sense lines or drive lines) along a geodesic on the curved surface has a magnitude in a range from about 500 µm to about 5 mm. The geodesic can be orthogonal to a second geodesic on the curved surface.

The sense lines 110 can be assembled on a substrate (not depicted in FIG. 1) that has defined optical properties and is electrically insulating, and also has a uniform thickness. As mentioned, the optical properties can include, for example, transmissivity, haze, UV stability, a combination thereof, or similar. In one aspect, the substrate can be transparent, translucent, or opaque depending on particular application of a touch sensor device that includes the substrate. The substrate has a defined dielectric strength. The magnitude of the uniform thickness can be in a range from about 10 µm to 5 mm. In some cases, the uniform thickness has a magnitude in a range from about 50 µm to 2 mm. The uniform thickness of the substrate permits assembly of other components of a display device and also permit capacitive sensing.

In some embodiments, the sense lines 110 can be assembled on a first surface of the substrate by treating the substrate according to a subtractive process or an additive process, or a combination of both. Such a treatment can result in sense lines 110 of essentially uniform thickness, where each one of the sense lines 110 can have a thickness in a range from about a few hundred nanometers (e.g., 300 nm, 400 nm, 500 nm, or 600 nm) to about 35 µm, in some cases. In other embodiments, the sense lines 110 can be assembled on the first surface of the substrate by using an adhesive to attach the sense lines 110 onto the first surface. The adhesive can be one of several types of adhesives that have defined optical properties and defined dielectric properties (such as dielectric constant, dielectric strength, or similar). As mentioned, the optical properties can include, for example, transmissivity, haze, UV stability, a combination thereof, or similar property. In some embodiments, the adhesive can be assembled in a multilayer structure that can provide a particular dielectric constant. The multilayer structure can include a first adhesive layer, a second adhesive layer, and a dielectric layer of a high-K material placed between the first adhesive layer and second adhesive layer. The first adhesive layer and the second adhesive layer can be contained in respective planes essentially parallel to the first surface of the substrate. In other embodiments, the adhesive can be assembled in a single layer including a filler dielectric material in order to achieve the particular dielectric constant. The filler dielectric material can be spatially distributed within the layer.

In some embodiments, the substrate can be embodied in, or formed from, a slab of a transparent and electrically insulating material. The substrate can be rigid or flexible. Accordingly, such a material can be a glass or plastic (e.g., polyester or polycarbonate). In embodiments in which the sense lines 110 are formed on the substrate by treating the substrate, the slab can have a precursor uniform thickness such that an additive treatment or subtractive treatment that yields the sense lines 120 results in a uniform thickness of the substrate in a range from about 10 µm to 5 mm.

In some configurations, the drive lines 120 also can be assembled on the substrate onto which the sense lines 110 are assembled. In some embodiments, the drive lines 120 can be assembled on a second surface the substrate by treating the substrate according to the subtractive process or the additive process, or a combination of both, used to form the sense lines 110. Such a treatment can result in drive lines 120 of essentially uniform thickness, where each one of the sense lines 110 can have a thickness in a range from about a few hundred nanometers (e.g., 300 nm, 400 nm, 500 nm, or 600 nm) to about 35 µm, in some cases. In other embodiments, the drive lines 120 can be assembled on a second surface of the substrate by using an adhesive to attach the drive lines 120 onto the second surface. Regardless of the process to assembled the drive lines 120, the second surface of the substrate is opposite the first surface of the substrate, and the second surface is substantially parallel to the first surface.

In other cases, the drive lines 120 can be assembled on a second substrate (not depicted in FIG. 1). In some embodiments, the drive lines 120 can be assembled on a first surface of the second substrate by treating the second substrate according to a subtractive process or an additive process, or a combination of both. In other embodiments, the drive lines 120 can be assembled on the first surface of the second substrate by using an adhesive to attach the drive lines 110 onto the first surface of the second substrate. The second substrate also can be transparent and electrically insulating and has a uniform thickness. The second substrate can be oriented parallel to the substrate onto which the sense lines 110 are assembled. The magnitude of the uniform thickness of the second substrate can be in a range from about 10 µm to 5 mm. In some cases, the uniform thickness has a magnitude in a range from about 50 µm to 2 mm. The uniform thickness of the substrate permits assembly of other components of a display device and also permit capacitive sensing.

In some embodiments, the second substrate can be embodied in, or can be formed from, a slab of a transparent and electrically insulating material. The second substrate can be rigid or flexible. Accordingly, such a material can be a glass or a plastic (e.g., polyester or polycarbonate). In embodiments in which the drive lines 120 are formed on the second substrate by treating the second substrate, the slab can have a precursor uniform thickness such that the additive treatment or subtractive treatment that yields the drive lines 120 results in a uniform thickness of the substrate in a range from about 10 µm to 5 mm.

A transparent adhesive layer can attach the substrate having the sense lines 110 assembled thereon and the second substrate having the drive lines 120 assemble thereon. Thus, a monolithic transparent sensor slab that contains the sense lines 110 and the drive lines 120 can be formed.

The touch sensor device that includes the sense lines 110 and the drive lines 120 also includes, in some embodiments, a touch layer that overlays the monolithic sensor slab. The touch layer can be exposed to an environment of the touch sensor that include the sensing assembly 200, and can permit interaction between an end-user and the touch sensor. In some cases, the touch layer can be monolithically integrated into the substrate having the sense lines 110. Specifically, the touch layer can be formed on a second surface of the substrate, where the second surface is opposite the surface forming an interface with the sense lines 110. In other cases, the touch layer can be affixed to the second surface. Regardless of the mechanism to incorporate the touch layer into the touch sensor, the touch layer can be embodied in, or can constitute, for example, an antimicrobial coating, an antiglare coating, anti-fingerprint coating (e.g., an oleophobic coating), a hydrophobic coating, a scratch-resistant coating, a polarizing coating, a translucent coating, a color-filtered coating, a partially opaque coating, a fully opaque coating, a combination thereof, or similar.

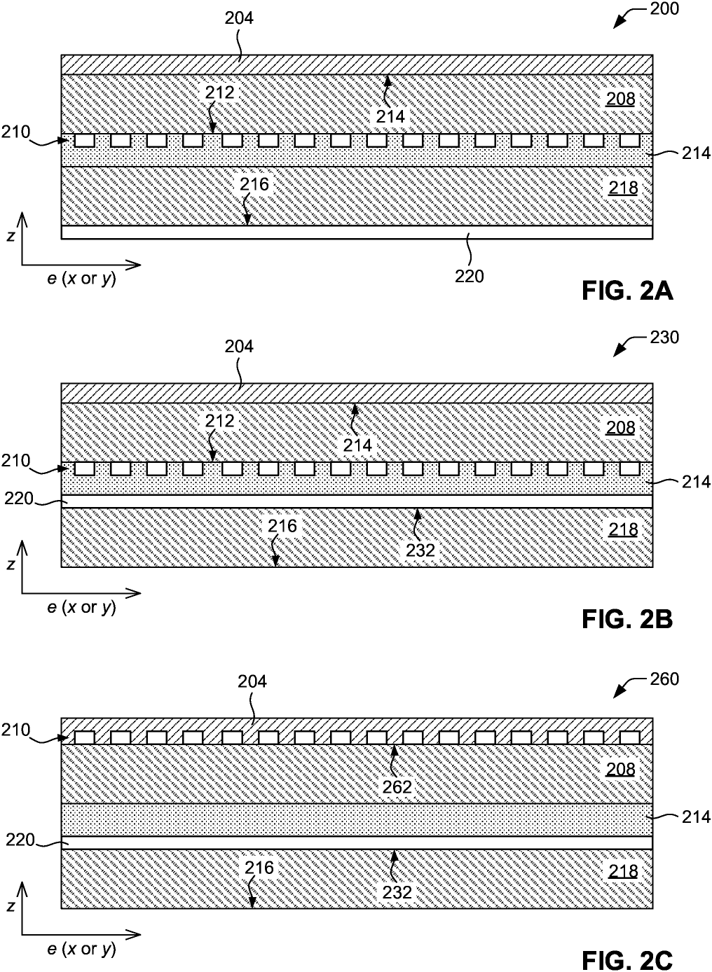

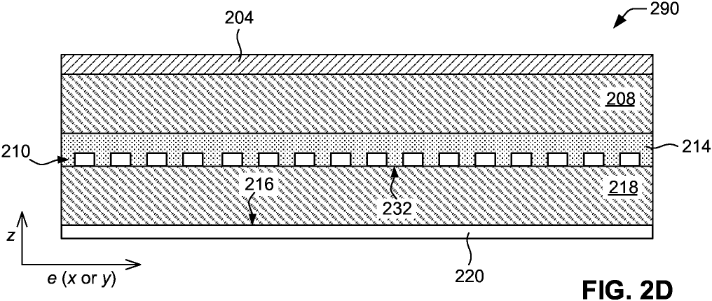

For purposes of illustration, FIG. 2A, FIG. 2B, FIG. 2C, and FIG. 2D illustrate examples of monolithic sensor assemblies, in accordance with one or more embodiments of this disclosure. The configuration of each one of the sensing assemblies illustrated in FIGS. 2A to 2D can be referred to as a single- sided dual-substrate configuration. Specifically, FIG. 2A is a schematic cross-section of an example of a sensing assembly 200 including sense lines 210 and drive lines 220. The sense lines 210 are oriented along a direction that is orthogonal to an e direction (either x direction or y direction) orthogonal to the z direction. The drive lines 220 are parallel to the e direction. The sense lines 210 are assembled on a first surface 212 of a first substrate 208, and the drive lines 220 are assembled on a first surface 216 of a second substrate 218. The sensing assembly 200 also includes a transparent adhesive layer 214 that attaches the first substrate 218 and the second substrate 218. The sensing assembly 200 further includes a touch layer 204 that forms an interface 215 with the substrate 208. As mentioned, in some embodiments, the touch layer 204 may be absent.

The relative position of the sense lines 210 and the drive lines 220 can be changed by leveraging another surface of the second substrate 218. To that point, FIG. 2B is a schematic cross-section of an example of a sensing assembly 230 including the sense lines 210 and drive lines 220. The sense lines 210 are assembled on the first surface 212 of the first substrate 208, and the drive lines 220 are assembled on a second surface 232 of the second substrate 218. The sensing assembly 230 also includes the transparent adhesive layer 214 that attaches the first substrate 218 and the second substrate 218. The sensing assembly 230 further includes the touch layer 204 forming the interface 215 with the first substrate 208. As mentioned, in some embodiments, the touch layer 204 may be absent.

Further, another arrangement of the sense lines 210 and the drive lines 220 can leverage another surface of the first substrate 208. FIG. 2C is a schematic cross-section of an example of a sensing assembly 260 including the sense lines 210 and drive lines 220. The sense lines 210 are assembled on a second surface 262 of the first substrate 208, and the drive lines 220 are assembled on the second surface 232 of the second substrate 218. The second surface 262 is opposite the first surface 212. The sensing assembly 260 also includes the transparent adhesive layer 214 attaching the first substrate 218 and the second substrate 218. The sensing assembly 260 further includes the touch layer 204 forming an interface with the second surface 262 of the substrate 208. As mentioned, in some embodiments, the touch layer 204 may be absent.

As mentioned, sense lines and drive lines of a touch sensor can be formed on opposite surfaces of a single substrate. FIG. 2D is a schematic cross-section of a sensing assembly 290 where the sense lines 210 and the drive lines 220 are assembled in such a configuration-namely, the sense lines 210 can be assembled on the second surface 232 of the second substrate 218 and the drive lines 220 can be assembled on the first surface 216 of the second substrate 218. In such a configuration, the second substrate 218 embodies a dielectric layer between drive lines 220 and sense lines 210. The sensing assembly 290 also includes the transparent adhesive layer 214 that attaches the first substrate 208 and the second substrate 218. The sensing assembly 290 further includes the touch layer 204 forming the interface 214 with the first substrate 208. As mentioned, in some embodiments, the touch layer 204 may be absent. The configuration of the sensing assembly 290 can be referred to as dual-sided single-substrate configuration.

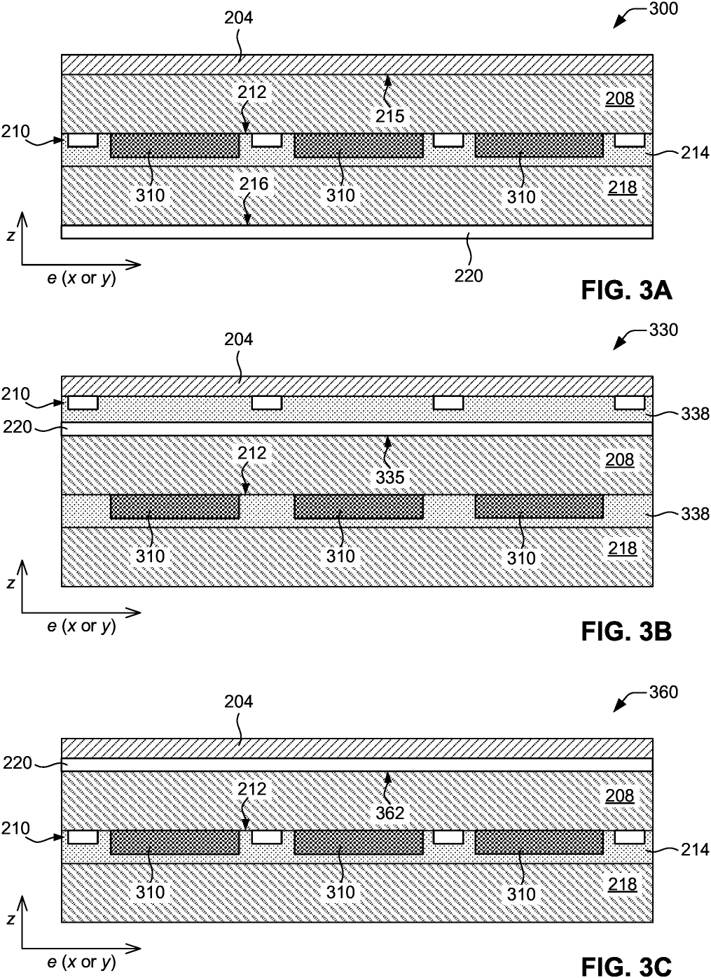

Display elements can be integrated into sensing assemblies described above in order to form a display device having touch sensing functionality. For example, FIG. 3A is a schematic cross-section of a display device 300 that includes several display elements 310 intercalated between sense lines 210. Each display element 310 can be formed on the surface 212 of the first substrate 208. As another example, FIG. 3B is a schematic cross-section of a display device 330 that includes several display elements 310. Each display element 310 can be formed on the surface 212 of the first substrate 208. The drive lines 220 can be assembled on a surface 335 opposite the surface 212. The sense lines 210 can be assembled on a surface of the touch layer 204, the surface being opposite the surface 335. A first transparent adhesive layer 338 attaches the first substrate 208 and the second substrate 218, and a second transparent adhesive layer attaches the first substrate 208 and the touch layer 204. As yet another example, FIG. 3C is a schematic cross-section of a display device 360 that also includes several display elements 310 intercalated between sense lines 210. The sense lines 210 can be assembled on the first surface 212 of the first substrate 208, and the drive lines 220 can be assembled on a second surface 362 of the first substrate 208, where the second surface 362 is opposite the first surface 212.

With further reference to FIG. 1, the sense lines 110 can be connected to a first connector 130 by routing traces 134. In some cases, the sense lines 110 and the routing traces 134 are arranged in a one-to-one configuration where each one of the sense lines 110 is coupled to a respective one of the first routing traces 134.

In some embodiments, each one of the routing traces 134 can be embodied in piecewise rectilinear traces or curved traces depending on the surface of the connecting pad 138. In other embodiments, at least one first routing trace of the routing traces 134 can be embodied in piecewise rectilinear trace(s), and at least one second routing trace of the routing traces 134 can be embodied in curved trace(s). At least sections of respective ones of the routing traces 134 can be assembled to be essentially parallel to one another in order to reduce asymmetric interference. Deviations from a parallel configuration of sections of routing traces 134 also can be present, but two or more of those sections are not necessarily perpendicular. Such deviations can result from assembling the routing traces 134 to reduce conductivity variation amongst a long routing trace (e.g., the longest routing trace) and a short routing trace (e.g., the shortest routing trace). It is noted that number of routing traces 134 is not limited to the number of routing traces 134 depicted in FIG. 1.

A first routing trace of the routing traces 134 can be embodied in metallic pad and a second routing trace of the routing traces 134 can be embodied in a second metallic pad. The metallic pad and the second metallic pad can be formed using any treatment process. The treatment process can be utilized to treat a surface of the connecting pad 138 to form each one of the routing traces 134. In some embodiments, the treatment process can be additive. An example of an additive process is printing, such as printing an amount of Ag ink or an amount of another type of conductive ink on an insulating substrate (such as polyethylene terephthalate (PET)) that embodies the connecting pad 138. In other embodiments, the treatment process can be a subtractive process where an etchant is used to remove a portion of a uniformly conductive planar surface to form a routing trace. The uniformly conductive planar surface can be embodied in a layer that has been coated with metal nanowires, a sputtered metal, an electrodeposited annealed metal, a rolled annealed metal, or similar conductive coating.

Fewer or more routing traces 134 than those shown in FIG. 1 can be assembled in a touch sensor device. Indeed, in some embodiments, at least one trace (not depicted in FIG. 1) can be added to the routing traces 134 to provide perimeter grounding rather than connect to one of the sense lines 110. A trace that provides perimeter grounding can be referred to as a shielding trace.

The drive lines 120 can be coupled to a second connector 140 by routing traces 144. In some cases, the drive lines 120 and the routing traces 144 are arranged in a one-to-one configuration where each one of the drive lines 120 is coupled to a respective one of the routing traces 144.

In some embodiments, each one of the routing traces 144 can be embodied in a piecewise rectilinear trace or curved trace depending on the surface of the connecting pad 148. In other embodiments, at least one first routing trace of the routing traces 144 can be embodied in piecewise rectilinear trace, and at least one second routing trace of the routing traces 144 can be embodied in a curved trace. At least sections of respective ones of the routing traces 144 can be assembled to be essentially parallel to one another in order to reduce asymmetric interference. Deviations from a parallel configuration of sections of routing traces 144 also can be present, but not necessarily perpendicular. Such deviations can result from assembling the routing traces 134 to reduce conductivity variation amongst a long routing trace (e.g., the longest routing trace) and a short routing trace (e.g., the shortest routing trace). It is noted that number of routing traces 144 is not limited to the number of routing traces 144 depicted in FIG. 1.

A first routing trace of the routing traces 144 can be embodied in metallic pad and a second routing trace of the routing traces 144 can be embodied in a second metallic pad. The metallic pad and the second metallic pad can be formed using any treatment process. The treatment process can be utilized to treat a surface of the connecting pad 148 to form each one of the routing traces 144. In some embodiments, the treatment process can be additive. An example of an additive process is printing, such as printing an amount of Ag ink or an amount of another type of conductive ink on an insulating substrate (such as PET) that embodies the connecting pad 148. In other embodiments, the treatment process can be a subtractive process where an etchant is used to remove a portion of a uniformly conductive planar surface to form a routing trace. The uniformly conductive planar surface can be embodied in a layer that has been coated with metal nanowires, a sputtered metal, or similar conductive coating.

Fewer or more routing traces 144 than those shown in FIG. 1 can be assembled in a touch sensor device. Indeed, in some embodiments, at least one trace (not depicted in FIG. 1) can be added to the routing traces 144 to provide perimeter grounding rather than connect to one of the sense lines 110. As mentioned, a trace that provides perimeter grounding can be referred to as a shielding trace.

Patterned confined conductive areas (referred to as conductive islands) can be formed between adjacent sense lines of the sense lines 110. The conductive islands are represented by rectangles in the diagram 100. A conductive material that forms the conductive islands can be transparent or non-transparent.

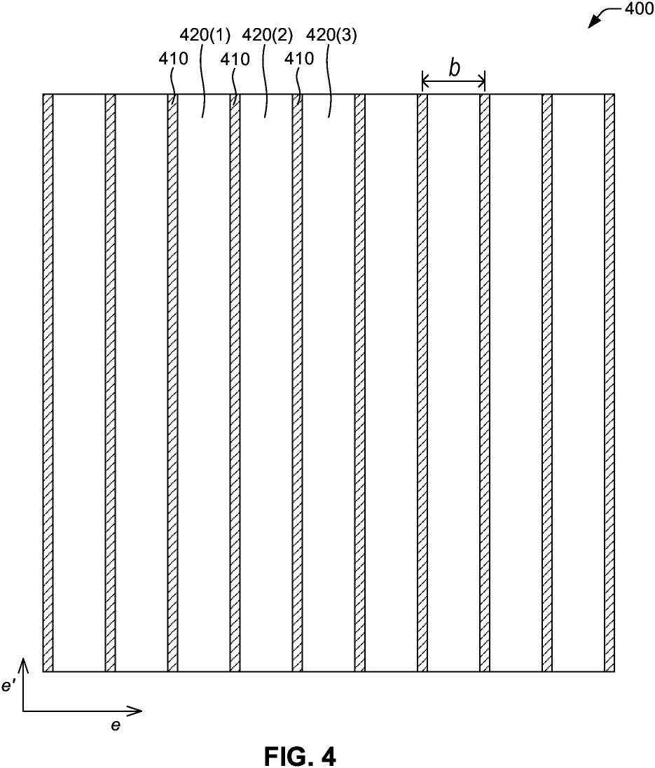

FIG. 4 illustrates a section of an example array 400 of conductive members, in accordance with one or more embodiments of this disclosure. The array 400 can embody, or can include, an array of drive lines. The array 400 can be assembled on a solid surface that is a substantially planar surface, and includes conductive members that are elongated and essentially parallel to one another. Each one of the first conductive members extends along a first direction e′. The first conductive members form a periodic structure along a second direction e orthogonal to the first direction e′, where the second direction e and the first direction e are contained on a same plane. The periodic structure has a pitch b having a magnitude in a range from about 500 µm to about 5 mm.

Adjacent conductive members in the array 400 are separated by a dielectric region 410 that serves an isolation line. That dielectric region 410 is elongated and has an essentially uniform width w_{d}. In one embodiment, the dielectric region 410 can be embodied in a strip of dielectric material (e.g., aluminum nitride, silicon dioxide, aluminum oxide, or similar). As is shown in FIG. 4, a first conductive member 420(1) is separated from an adjacent second conductive member 420(2) by a first dielectric region 410. Additionally, the second conductive member 420(2) is separated from an adjacent third conductive member 420(3) by a second dielectric region 410. The conductive members in the array 400 can be self-shielding due to the high density of conductive members in that array. That is, capacitive coupling among adjacent conductive members can be mitigated, or even avoided altogether, due to a large ratio between width w_{c} of a conductive member and the width w_{d} of a dielectric region 410. The pitch b is equal to w_{c} + w_{d}. In some embodiments, w_{c} can be in a range from about 0.8 b to about 0.99 b. Accordingly, magnitude of w_{c} can be in a range from about 500 µm to about 4.95 mm in some cases.

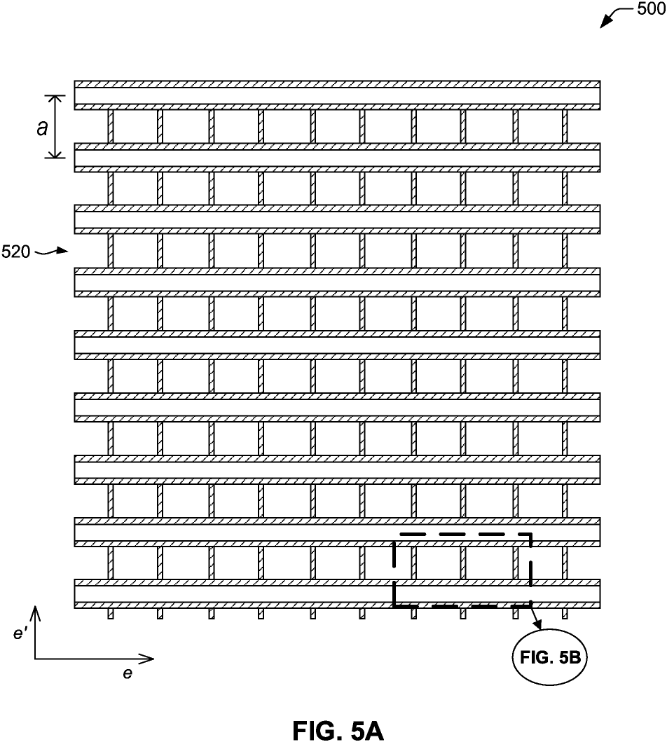

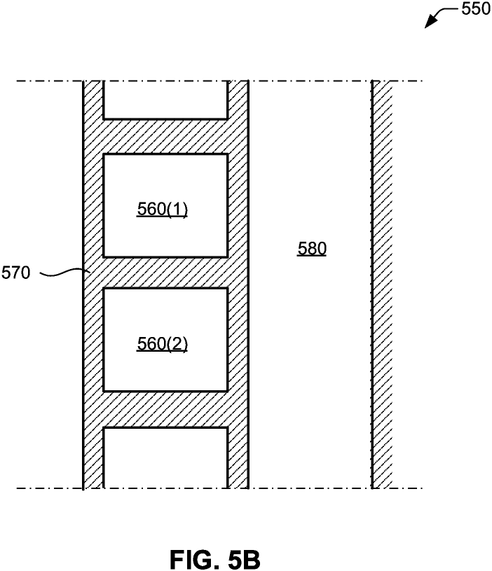

FIG. 5A illustrates a section of an example array 500 of conductive members, in accordance with one or more embodiments of this disclosure. The example array 500 can embody, or can include, an array of sense lines. The array 500 can be assembled on a solid surface that is a substantially planar surface, and includes first conductive members that are elongated and essentially parallel to one another. Each one of the first conductive members extends along a first direction e. The first conductive members form a periodic structure along a second direction e′ orthogonal to the first direction e, where the second direction e′ and the first direction e are contained on a same plane. The periodic structure has a pitch a. As mentioned, the pitch a has a magnitude in a range from about 500 µm to about 5 mm. In one example, a is equal to 1 mm. In another example, a is equal to 2 mm. The first conductive members constitute an array that has a filling factor (FF) having a magnitude in a range from about 0.25 to about 0.50. In this disclosure, FF defines a spatial overlap between a conductive member in a first array of conductive members (e.g., sense lines) and another conductive member in a second array of conductive members (e.g., drive lines). The spatial overlap can be quantified as a proportion of the coverage of the conductive member (e.g., a sense line) on the other conductive member (e.g., a drive line). Thus, FF can be indicated with a real number in the interval (0,1].

Magnitude of FF can result from a tradeoff between achieving lower resistance per member (which can be obtained with wider lines) and simplifying device processing (which can be accomplished with wider lines). In other words, that magnitude can result from a tradeoff between achieving higher resolution and simplifying fabrication of a touch sensor device. The magnitude of FF also can depend on the type of conductive material (and, thus, conductivity) that forms the first conductive members.

The array 500 also includes second conductive members 520 placed between adjacent first conductive members. The second conductive members 520 form a lattice along the direction e. A dielectric region (represented by a hatched surface in FIG. 5A) separates the second conductive members 520 from one another and from adjacent ones of the first conductive members. As mentioned, the dielectric region can be embodied in a void or a dielectric material. Accordingly, the dielectric region can be transparent or non-transparent. The dielectric material can be applied after the conductive members in the array 500 are formed on a solid surface. In some cases, the dielectric material can be conformally applied by laminating the dielectric material onto the conductive members that constitute the array 500. As a result, the dielectric material can fill voids between the conductive members. Concurrently, as a further result of that lamination, a dielectric layer that separates the conductive members from other conductive members (e.g., drive lines) also can be formed. In other cases, the dielectric material can be applied in a distinct processing step before forming such a dielectric layer. Different dielectric materials can be used and can be applied distinctly. The purpose of applying a dielectric material is to separate the drive and sense lines. In one example embodiment, the dielectric material is an adhesive, usually thick 25-100um and is conformal by virtue of its ability to flow into the gap. With such a dielectric material in its liquid equivalent, it is possible to achieve an intimate lamination. In another example embodiment, wherein the sense and drive lines are on the same surface, printed dielectric material can be added as a bridge to allow the sense or drive lines to crossover each other. The dielectric material can be selected to achieve a desired dielectric property. The thickness of the printed material can be low (e.g. 10-30 um) to ensure that the step height of the conductive part of the bridge is low enough to ensure 100% connection. The dielectric material can be adhesive or non-adhesive.

Further, each one of the second conductive members 520 is confined and has a defined shape that is common across those conductive members. The defined shape can be determined by the type of process―additive process or subtractive process, for example― applied to form the second conductive members 520. More specifically, in example embodiments in which an additive process is applied, the defined shape can be essentially an object of revolution about an axis perpendicular to a plane that contains the second conductive members 520. In some cases, the object of revolution can have a bell-shaped cross section having a profile of thicknesses that corresponds to an essentially normal distribution of thicknesses. The defined shape can be a parallelepiped in example embodiments in which a subtractive process is applied. The parallelepiped can have a thickness that is significantly smaller than the length of a side of the parallelepiped. The thickness can have a magnitude that ranges from a few hundred nanometers (e.g., 300 nm, 400 nm, 500 nm, or 600 nm) to about 35 µm, in some cases. The largest magnitude that can be attained for that thickness can be determined by the type of conductive material that constitutes the second conductive members 520. The rectangular cross-sectional area of the parallelepiped is shown in FIG. 5A. The defined shape can have other geometries in other embodiments. In some cases, the cross-sectional area of the defined shape can be one of a square, a rectangle, a triangle, or another type of polygon. In other cases, that cross-sectional area can have an irregular shape having a bounding line that is either curved or includes edges and one or more vertices. The particular defined shape of a conductive island can correspond to the geometry of the overlap of a sense line and drive line.

In some embodiments, the array 500 can be formed by patterning a layer of a conductive material having a uniform thickness. The conductive material can be transparent or non-transparent. The patterning can be performed on any suitable substrate configuration. In one example configuration, the layer of the conductive material can be patterned on a single-sided substrate (see FIG. 2B, for example). In another example configuration, the layer of the conductive material can be patterned on a dual-sided single-substrate configuration (see FIG. 2D, for example). Regardless of particular configuration, a substrate that supports the array 500 can be embodied in, or can include, a flexible layer or a rigid layer.

The patterning can be performed by implementing a process to treat a solid substrate. The process can be additive or subtractive can include one or several processing stages. In one embodiment, the process can include forming a layer of a conductive material (e.g., a simple metal, a noble metal, or a conductive ink). In some cases, the layer can be formed by spin-coating the conductive material on a substrate (e.g., PET substrate). In other cases, the layer can be printed on the substrate. In yet other cases, the layer can be formed by distributing a liquid phase of the conductive material using a squeegee and then allowing the liquid phase to solidify. The process also can include masking the layer according to a desired pattern of extended conductive members and confined conductive members (or conductive islands). The masking can yield multiple areas of exposed conductive material. The process can further include removing the exposed conductive material, resulting in an array of conductive members including conductive islands. The exposed conductive material can be removed by wet etching or ablation, for example.

For purposes of illustration, FIG. 5B depicts a subsection of the section of the example array 500 shown in FIG. 5A, the subsection includes multiple conductive islands and a portion of adjacent conductive members. As mentioned, the conductive material that forms the conductive islands can be transparent or non-transparent. The section depicts a first conductive island 560(1) and a second conductive island 560(2) that are adjacent to one another, and both are adjacent to a conductive member 580. A dielectric region 570 (transparent or non-transparent) separates the first patterned conductive island 560(1) from the second patterned conductive island 560(2). The dielectric material also separates each one of those conductive islands from the conductive member 580. The dielectric material can be embodied in a ceramic dielectric, such as barium titanate, barium neodymium titanate, barium strontium titanate, barium tantalate, alumina, aluminum nitride, aluminum silicate or sillimanite, titania, titanate, zirconia, zirconate, zircon, zirconium tin titanate, silica, silicate, beryllia, boron nitride, calcium titanate, calcium magnesium titanate, glass ceramic, cordierite/magnesium aluminum silicate, forsterite/magnesium silicate, lead magnesium niobate, lead zinc niobate, lithium niobate, magnesium silicate, magnesium titanate, niobate, niobium oxide, quartz, sapphire, tantalate, tantalum oxide, steatite, strontium titanate, or similar. In other cases, the dielectric material can be an adhesive, such as an acrylic pressure-sensitive adhesive (PSA), an optical clear adhesive (OCA), urethane, or similar.

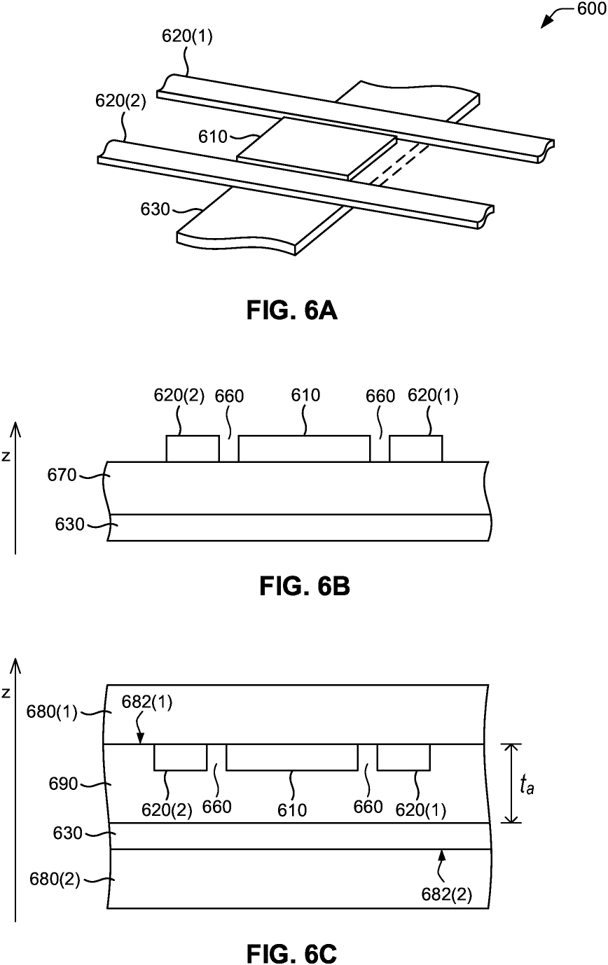

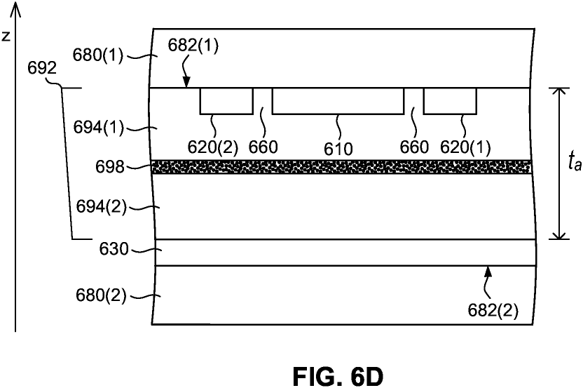

In some embodiments, patterned conductive islands can be capacitively coupled to drive lines in a touch sensor device. As an example, FIG. 6A illustrates a perspective view of a detail section 600 of the array 500 shown in FIG. 5A. Specifically, FIG. 6A illustrates capacitive coupling between a patterned conductive island 610 in the array 500 of conductive members and a conductive member 630 in a second array of conductive members (e.g., the array 400 (FIG. 4)). As mentioned, the array 500 can be assembled on a first solid surface. The conductive member 630 can be assembled on a second solid surface opposite the first solid surface. The array 500 includes a first conductive member 620(1) and a second conductive member 620(2) adjacent to the first conductive member. As is illustrated in FIG. 6A, the patterned conductive island 610 is adjacent to the first conductive member 620(1) and the second conductive member 620(2).

The first conductive member 620(1) and the second conductive member 620(2) are substantially parallel to one another, and are elongated along the direction e. In the geometry illustrated in FIG. 6A, the patterned conductive island 610 has a first side along a first direction that is transversal to the first conductive member 620(1) and the second conductive member 620(2). In addition, the patterned conductive island 610 has a second side along the direction e, which is parallel to the first conductive member 620(1) and the second conductive member 620(2). In some embodiments, a length of the first side ranges from about 10 µm to about 3 mm, and a length of the second side ranges from about 500 µm to about 3 mm. In one example, the length of the first side can have a length of 722 µm and the length of the second side can be 900 µm. In one example, the length of the first side can have a length of 444 µm and the length of the second side can be 900 µm. In some examples, there can be two separate islands 610 between the drive lines 620(1) and 620(2). One of the islands 610 can be electrically unconnected (or floating).

As is illustrated in FIG. 6A, the conductive island 610 can have a shape that overlays a portion of the conductive member 630 (e.g., a drive line), with a similar overlapping geometry so as to create a facsimile of an in-plane array without a dielectric bridge. Because of the capacitive coupling between the conductive island 610 and the conductive member 630, such an arrangement can provide improved sensitivity by effectively moving the drive lines in a second array of conductive members to a same plane that contains sense lines in the array 500. The improved sensitivity can arise from the creation of an effectively two-dimensional dense assembly of sensing lines.

As mentioned, a patterned conductive island can be separated from adjacent conductive members by a dielectric region. As is illustrated in the cross-sectional view of the section 600 shown in FIG. 6B, the dielectric region can be embodied in a void 660. The disclosure is not limited in that respect and, in some embodiments, the dielectric region can be embodied in a dielectric layer. Although not depicted in FIG. 6A for the sake of clarity, a solid layer 670 can separate the first conductive member 620(1), the second conductive member 620(2), and the patterned conductive island 610 from the conductive member 630. In some embodiments, the solid layer 670 can constitute a substrate including one of a flexible layer or a rigid layer having a uniform thickness. A magnitude of the uniform thickness can be in a range from about 10 µm to about 5 mm.

In some embodiments, as mentioned, the active area patterning that creates conductive islands can be implemented in a single-sided dual-substrate configuration. In such a configuration, as is shown in FIG. 6C, the solid surface onto which the array 500 (FIG. 5A) is formed is embodied in a first solid surface 682(1) that pertains to a first substrate 680(1). Accordingly, the first conductive member 620(1) and the second conductive member 620(2) can be formed on the first solid surface 682(1). As is further shown in FIG. 6C, the conductive member 630 can be formed on a second solid surface 682(2) that pertains to a second substrate 680(2).

The first substrate 680(1) has a uniform thickness of a magnitude within a range from about 10 µm to about 5 mm, and can include one of a flexible layer or a rigid layer. The second substrate 680(2) has a second uniform thickness of a magnitude also within a range from about 10 µm to about 5 mm, and can include a second flexible layer or a second rigid layer. In some embodiments, the first substrate 680(1) is embodied in the flexible layer and the second substrate 680(2) is embodied in the second flexible layer. In other embodiments, the first substrate 680(1) is embodied in the rigid layer and the second substrate 680(2) is embodied in the second rigid layer.

An adhesive layer 690 can attach the first substrate 680(1) and the second substrate 680(2) to one another. The adhesive layer 690 can be transparent or non-transparent. The adhesive layer 690 can have a uniform thickness tₐ and defined dielectric properties that provide a satisfactory performance (optimal or nearly optimal performance, for example) of a touch sensor device that that includes the assembly shown in FIG. 6C. The defined dielectric properties include dielectric constant, dielectric strength, or similar. To that point, as is illustrated in FIG. 6D, the adhesive layer 690 can be embodied in a multilayer structure 692 that provides a particular dielectric constant. The multilayer structure 692 can include a first adhesive layer 694(1), a second adhesive layer 694(2), and a dielectric layer 698 of a high-K material placed between the first adhesive layer 694(1) and second adhesive layer 694(2). The first adhesive layer 694(1) and the second adhesive layer 694(2) can be essentially parallel to one another. In other embodiments, the adhesive layer 690 can include a filler dielectric material in order to achieve the particular dielectric constant. The filler dielectric material can be spatially distributed within the layer 690.

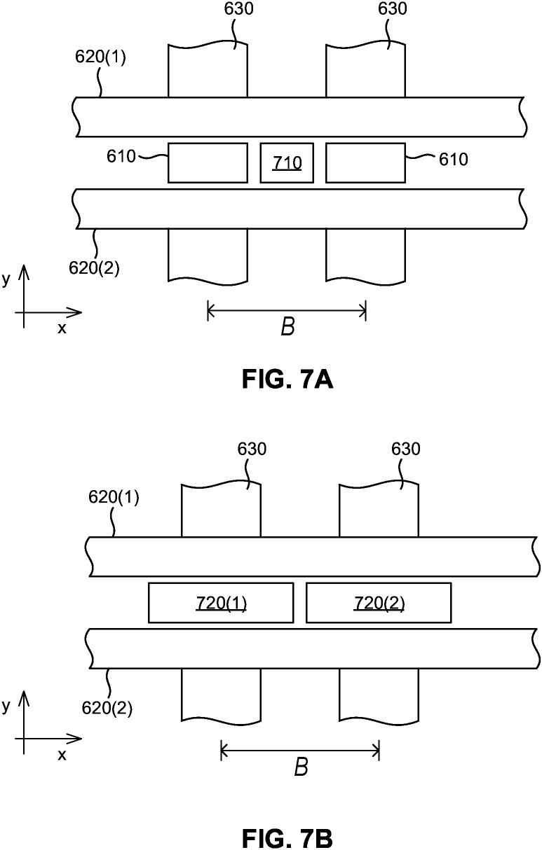

In some embodiments, the pitch of an array of drive lines (see pitch b in FIG. 4, for example) can be large (e.g., 500 µm to 1 mm or greater) and, thus, a conductive island can be formed in the spacer dielectric region between adjacent drive lines. Such a conductive island can be referred to as a “floating” conductive island. FIG. 7A illustrates an example of conductive islands placed between adjacent conductive members (e.g., sense lines), in accordance with one or more embodiments of this disclosure. FIG. 7A is a schematic top view (e.g., a projection on the x-y plane in the coordinate system shown in FIG. 1) of the example conductive islands and other conductive members shown therein. The adjacent conductive members can embody sense lines and include the first conductive member 620(1) and the second conductive member 620(2). The pitch B between a first conductive member 630 and a second conductive member 630 can be sufficiently large that a floating conductive island 710 can be formed between a conductive island 610. Each one of the first patterned conductive island 610 and the second patterned conductive island 610 can overlay a portion of respective conductive member 630 (e.g., a drive line), as is described in connection with FIG. 6A for example. The floating conductive island 710 can overlay a portion of the dielectric region that separates the first conductive member 630 and the second conductive member 630.

A large pitch of the array of drive lines also can permit forming larger conductive islands, each partially overlaying the spacer dielectric region, instead of forming a floating conductive island placed between adjacent conductive islands. As is illustrated in FIG. 7B, a first conductive island 720(1) can overlay a portion of the first conductive member 630, and a second conductive island 720(2) can overlay a portion of the second conductive member 630. The first conductive island 720(1) also can overlay a portion of the dielectric region that separates the first conductive member 630 and the second conductive member 630. Similarly, the second conductive island 720(2) can overlay a second portion of that dielectric region. The first conductive island 720(1) and the second conductive island 720(2) can be patterned or otherwise formed using the additive process and/or subtractive process used to form other patterned conductive islands described herein. Accordingly, the morphology of each one of the first conductive island 720(1) and the second conductive island 720(2) can be similar to the morphology of the patterned conductive island 610 in terms of thickness and size. FIG. 7B is a schematic top view (e.g., a projection on the x-y plane in the coordinate system shown in FIG. 1) of the example conductive islands and other conductive members shown therein.

Higher sensitivity can be achieved without changing the footprint (e.g., pitch) of conductive members in the array 500 by creating a conductive coupling between the array 500 and a second array of conductive members (e.g., the array 400 (FIG. 4)). The conductive coupling can be provided by multiple conductive coupling members that connect respective patterned conductive islands and sections of conductive members in the second array. The conductive coupling member can be integrated to the conductive island in some cases.

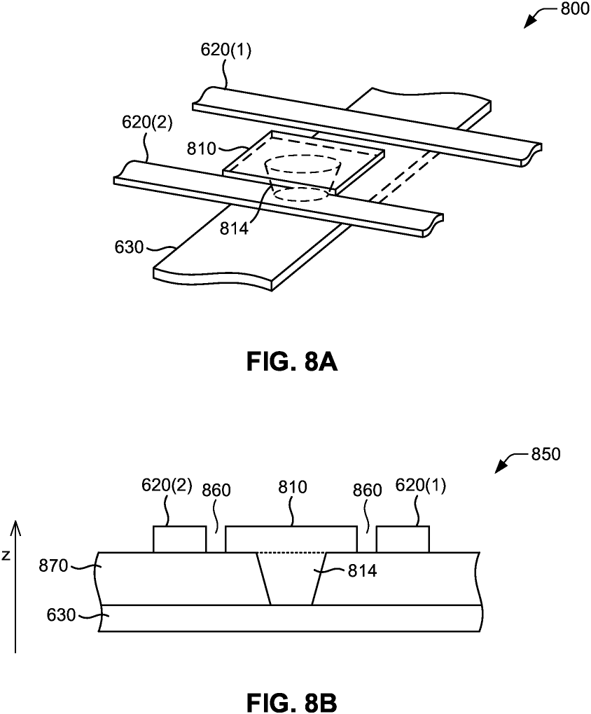

FIG. 8A illustrates an example of conductive coupling between a patterned conductive island 810 in the array 500 of conductive members and the conductive member 630 in the second array of conductive members, in accordance with one or more embodiments of this disclosure. As mentioned, the first conductive member 620(1) and the second conductive member 620(2) are substantially parallel to one another, and are elongated along the direction e. In the geometry illustrated in FIG. 8A, the patterned conductive island 810 has a first side along a first direction that is transversal to the first conductive member 620(1) and the second conductive member 620(2). In addition, the patterned conductive island 810 has a second side along the direction e, which is parallel to the first conductive member 620(1) and the second conductive member 620(2). In some embodiments, a length of the first side can range from about 500 µm to about 3 mm, and a length of the second side can range from about 10 µm to about 3 mm.

The patterned conductive island 810 is attached to a coupling member 814 at a first end of the coupling member 814. In some cases, the coupling member 814 is monolithically integrated with coupling member 814. Thus, the coupling member 814 is seamlessly attached to the coupling member 814. In other cases, the coupling member 814 is affixed to a surface of the patterned conductive island 810. As is shown in FIG. 8A, the coupling member 814 can be embodied in a truncated cone. The coupling member 814 is affixed to the conductive member 630 at a second end of the coupling member 814. The second end is opposite to the first end.

Although the coupling member 814 is illustrated as a truncated cone, the disclosure is not limited is that respect. Indeed, in some embodiments, a coupling member can be embodied in an object of revolution about an axis that extends from the first end to the second end. Simply for purposed of illustration, the object of revolution can be embodied in a cylinder, an ellipsoid, a dome, or a sphere. In other embodiments, the coupling member can have a cross-section of a defined geometry on a plane perpendicular to a line that extends from the first end to the second end. The defined geometry can be a regular polygon, an irregular polygon, a circle, an ellipse, or another type of closed curve.

The patterned conductive island 810 can be separated from adjacent conductive members 620(1), 620(2) by a dielectric region. As is shown in FIG. 8B, the dielectric region can be embodied in an air gap 860. The disclosure is not limited in that respect and, in some embodiments, the dielectric region can be embodied in a dielectric layer. Although not depicted in FIG. 8A for the sake of clarity, a layer 870 can separate the first conductive member 620(1), the second conductive member 620(2) from the conductive member 630. In some embodiments, the solid layer 670 can constitute a substrate including one of a flexible layer or a rigid layer having a uniform thickness. A magnitude of the uniform thickness can be in a range from about 10 µm to about 5 mm.

The coupling member 814 provides a physical conductive connection between the isolated island 810 on the array 500 and the conductive member 630. As is described herein, the array 500 can embody a sense array of a touch sensor device and the conductive member 630 can embody a drive line in a drive array of the touch sensor device.

There are numerous ways of forming the coupling member 814. In some embodiments, in a dual-sided single-substrate configurations, the layer 870 can be embodied in a PCB substrate having an array of through-hole vias that can be electroplated. The PCB substrate can have a first planar solid surface and a second planar solid surface opposite the first planar solid surface. The first planar solid surface and the second planar solid surface can be terminal surfaces pertaining to the PCB substrate, and thus, such surfaces can be spatially separated by a distance corresponding to the PCB substrate. Each one of the through-hole vias in the array is oriented along a direction perpendicular to the first planar solid surface and the second planar solid surface. Further each one of the through-hole vias in the array forms an opening on the first planar solid surface and the second planar solid surface. That array serves as precursor perforations that define the location of conductive islands.

In some cases, the second planar solid surface can be treated to form a first array of conductive members that are elongated along that surface and are essentially parallel to one another. The first array of conductive members can embody an array of drive lines (e.g., drive lines 120) and can cover the openings defined by the array of through-hole vias. Such a treatment can include an additive process or a subtractive process for forming conductive members.

In addition, the first planar solid surface can be treated to fill the precursor perforations. The treatment can be additive and can include depositing a conductive material (a metal, for example) that fills the precursor perforations. By filling the precursor perforations, conductive coupling members (including the coupling member 814, for example) can be formed at the location of those perforations. Deposition of the conductive material also can result in covering the first planar solid surface with a layer of the conductive material. Accordingly, the treatment also can include removing such a layer by polishing, wet etching, or a similar process. As a result, the first planar solid surface can remain planar and simply connected; that is, the first planar solid surface can lack perforations.

The first planar solid surface can be further treated to form a second array of conductive members. The treatment can include an additive process and/or a subtractive process, in accordance with aspects described herein. The second array of conductive members can include multiple first conductive members that are elongated along that surface and are essentially parallel to one another. The multiple first conductive members can embody an array of sense lines (e.g., sense lines 120). Each one of the multiple first conductive members can be perpendicular to the first array of conductive members (e.g., drive lines). The second array of conductive members also includes multiple conductive islands covering respective filled precursor perforations. Thus, the multiple conductive islands can be connected to conductive members in the first array of conductive members (e.g., drive lines) by a coupling conductive member (including the coupling member 814, for example).

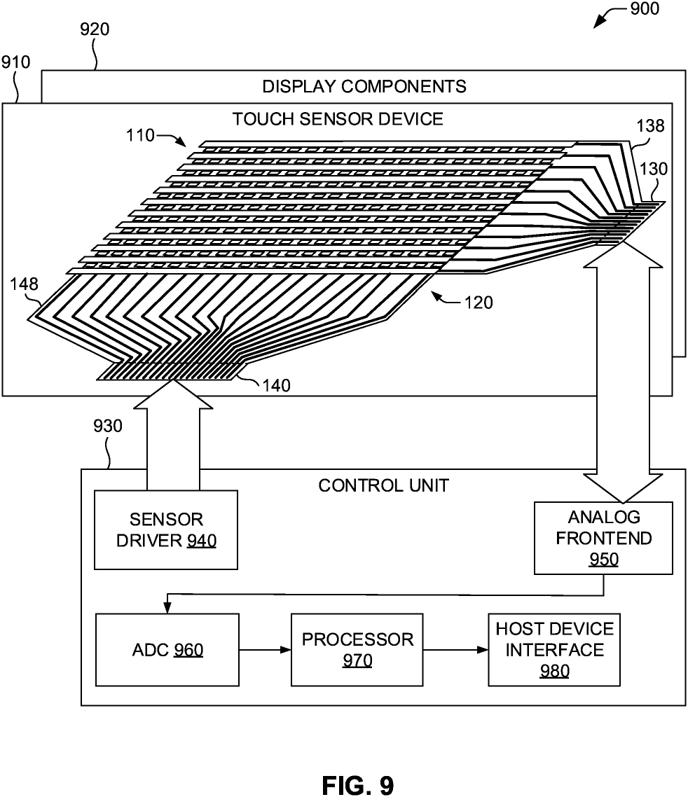

FIG. 9 illustrates an example of a display device 900 in accordance with one or more embodiments of this disclosure. The display device 900 includes a touch sensor device 910 including an array of conductive members assembled on a first solid surface, the array including a first conductive member and a second conductive member adjacent to the first conductive member. Simply for purposes of illustration, in FIG. 9, the array of conductive members can be embodied in the array of sense lines 110. The touch sensor device 910 also can include a conductive island adjacent to the first conductive member and the second conductive member, wherein the conductive island overlays, at a defined distance from, a third conductive member assembled on a second solid surface opposite the first solid surface.

The touch sensor device 910 can further include a second conductive island adjacent to the first conductive member and the second conductive member, the second conductive island being capacitively coupled to a fourth conductive member assembled on the second surface. The conductive island and the second conductive island are contiguous to one another, and a dielectric region separates the conductive island and the second conductive island.

In some embodiments, a coupling member coupled to the conductive island at a first end and further coupled to the third conductive member at a second end opposite the first end. The conductive coupling member can be formed from, or can include, a conductive material. As is described herein, the conductive coupling member can be an object of revolution about an axis that extends from the first end to the second end. In some cases, the conductive coupling member has a polygonal cross-section on a plane perpendicular to a line that extends from the first end to the second end.

The display device 900 also can include display components 920 that can permit presenting images to an end-user of a host device (such as a computing device; e.g., a mobile device or a tethered device). The relative arrangement of the display components 920 and the touch sensor device 910 shown in FIG. 9 is schematic. Various arrangements of the display components 920 relative to the elements of the touch sensor device 910 are possible. Although not depicted in FIG. 9, and consistent with embodiments described herein, the touch sensor device 910 can include a touch sensor layer that can be exposed to the end-user. The host device can cause changes to the images presented in the display components 920 in response to detecting particular sense points on the touch layer.

To detect one or more sense points using the touch sensor device 910, the display device 900 can include a control unit 930 that can process electric signals received from the touch sensor device 910. To that end, the control unit 930 can include a sensor driver 940 that can apply an electric signal (voltage, for example) to a routing trace that is coupled with one or several conductive members in the second array of conductive members (e.g., drive lines 120). The routing trace can be couple to the drive lines 120 via an interpolation structure. In an example interpolation structure, the drive lines can be integrated with one or more printed resistors, surface mounted (SMT) resistors or capacitors. It is to be appreciated that the active area patterning can be implemented via resistive interpolation or capacitive interpolation. In other words, the active area patterning in agnostic to the interpolation technique that is used. The sensor driver 940 can apply electric signals to several (each one, in some cases) of the routing traces and associated drive lines. The sensor driver 940 can be coupled to routing traces via electrical connections between the sensor driver 940 and a first connector of the touch sensor device 910. For instance, as is illustrated in FIG. 9, the first connector can be the connector 140.

Further to that end, the control unit 930 can include an analog frontend 950 that can receive analog electric signals from routing traces coupled to conductive members in the first array of conductive members (e.g., sense lines 110). The routing trace can be couple to the drive lines 120 via an interpolation structure. In an example interpolation structure, the drive lines can be integrated with one or more printed resistors, surface mounted (SMT) resistors or capacitors. The analog frontend 950 can receive an electric signal (voltage, for example) from a routing trace that is coupled, via one or more resistors, with one or several conductive members in the first array of conductive members (e.g., sense lines 110). The analog frontend 950 can be coupled to routing traces via electrical connections between the analog frontend 950 and a second connector of the touch sensor device 910. For instance, as is illustrated in FIG. 9, the second connector can be the connector 130.

The analog frontend 950 can supply the electric signals to an analog-to-digital converter 960 (ADC 960) that can transform the received analog electric signals to digital signals. The ADC 960 can supply the digital signals to a processor 970 that can detect sensor points by operating on the digital signals. Simply as an illustration, the processor 970 can be embodied a field-programmable gate array (FPGA), an application specific integrated circuit (ASIC), a digital signal processor (DSP), or a microprocessor. The processor 970 can supply data and/or signaling to a host device interface 980 that couples the control unit 930 with the host device. Such data represents the sense points.

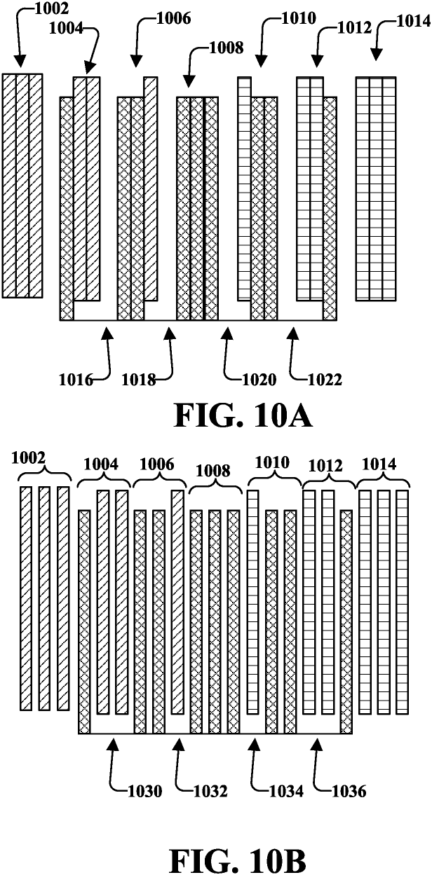

The conductive members 620(1), 620(2) can be implemented as bundles of electrodes. FIG. 10A illustrates an example, non-limiting, schematic representation of a LI version (or low configuration), which is a configuration where sub-electrodes are “bundled” together. The bundles consist of multiple sub-electrodes from the same or different electrodes, as will be described in further detail below. The electrodes (or sub-electrodes thereof) can be column (e.g., sense) electrodes or row (e.g., drive) electrodes. Although discussed with respect to the columns being sense and the rows being drive, the disclosed embodiments are not limited to this implementation and, in some embodiments, the columns can be drive and the rows can be sense. Illustrated in FIG. 10A are three different electrodes (e.g., main electrodes) divided into sub-electrodes, as indicated by the different patterns. In a 1-2-3-2-1 design, the bundles are in groups of three (e.g., 3+0, 2+1, 1+2, 0+3, 1+2, 2+1, 3+0, and so on). For a 1-2-1 design, there will be groups of 2 and so on.

For purposes of explanation, FIG. 10A illustrates the 1-2-3-2-1 design. From left to right, each bundle includes three sub-electrodes, which are bundled (e.g., interdigitated) as follows, where the depicted patterns indicate sub-electrodes of different electrodes. A first bundle 1002 includes three sub-electrodes of a first electrode and zero sub-electrodes from another electrode. A second bundle 1004 includes two sub-electrodes of the first electrode and one sub-electrode of a second electrode. A third bundle 1006 includes one sub-electrode of the first electrode and two sub-electrodes of the second electrode. A fourth bundle 1008 includes zero sub-electrodes of another electrode and three sub-electrodes of the second electrode. A fifth bundle 1010 includes one sub-electrode of a third electrode and two sub-electrodes of the second electrode. A sixth bundle 1012 includes two sub-electrodes of the third electrode and one sub-electrode of the second electrode. Further, a seventh bundle 1014 includes three sub-electrodes of the third electrode and zero sub-electrodes of another electrode. In an example embodiment, the three sub-electrodes of the seventh bundle 1014 can be used for capacitive interpolation. In such an embodiment, each sub-electrode can include two parallel plates for at least a portion of the length of the sub-electrode.

Between the sub-electrodes of each bundle, there are zero gaps, or substantially zero gaps. As utilized herein, “substantially zero gap” refers to the minimal gap allowed by the fabrication process. Further, there are equal gaps (or substantially equal gaps) between the bundles as indicated at 1016, 1018, 1020, and 1022. Thus, the LI version either has no gap (e.g., connected) or substantially zero gap within bundles, and gaps between bundles. According to some implementations, when there is a no gap situation in the LI version, there is one trace that is wider. For example, the trace is wider rather than having two or more sub-electrodes having respective smaller widths.

FIG. 10B illustrates an example, non-limiting, schematic representation of a HI version (or high configuration), which is a configuration where the sub-electrodes are “distributed.” Repetitive description of like elements employed in other embodiments described herein is omitted for sake of brevity. The electrodes (or sub-electrodes) thereof, can be column (e.g., sense) electrodes or row (e.g., drive) electrodes. In this case, the sub-electrodes are equally (or substantially equally) spaced or have equal (or substantially equal) gaps with its interdigitated neighbors.

By way of example and not limitation, the following will be described with respect to an analogy of the number of teeth of a comb. In an example of the 1-2-3-2-1 combination design, the LI version (e.g., low configuration) will have bundles of 1, 2, 3, 2, and 1 teeth and have either connected or substantially zero gaps within the bundles of 1, 2, 3, 2, and 1 teeth. There will still be gaps between the bundles of the comb and its interdigitated neighboring combs.

In an example of the 1-2-3-2-1 combination design, the HI version (e.g., high configuration) will have 1+2+3+2+1 teeth that are equally spaced and have equal gaps with its interdigitated neighbors.

In both examples provided above, each 1-2-3-2-1 combination with have five groups of teeth (excluding end cases) that are interdigitated with its neighboring combs.

Thus, a difference between the versions (e.g., LI and HI) is how the traces are being packed into groups. For example, where n =2, there is one additional bundle of traces in between each pair of traces that are usually in the pattern. In the LI version, the bundle is pressed together and in the HI version, the bundle is spread out.

In the present specification, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in this specification and annexed drawings should generally be construed to mean “one or more” unless specified otherwise or clear from context to be directed to a singular form.

In addition, the terms “example” and “such as” are utilized herein to mean serving as an instance or illustration. Any embodiment or design described herein as an “example” or referred to in connection with a “such as” clause is not necessarily to be construed as preferred or advantageous over other embodiments or designs. Rather, use of the terms “example” or “such as” is intended to present concepts in a concrete fashion. The terms “first,” “second,” “third,” and so forth, as used in the claims and description, unless otherwise clear by context, is for clarity only and does not necessarily indicate or imply any order in time or any particular spatial arrangement.

As is used herein, the term “about” indicates that each of the described dimensions is not a strict boundary or parameter and does not exclude functionally similar variations therefrom. Unless context or the description indicates otherwise, the use of the term “about” in connection with a numerical parameter indicates that the numerical parameter includes variations that, using mathematical and industrial principles accepted in the art (e.g., rounding, measurement or other systematic errors, manufacturing tolerances, etc.), would not vary the least significant digit.

Some relationships between dimensions of a touch sensor device and between elements of the touch sensor device may be described herein using the terminology “substantially equal.” As is used herein, the terminology “substantially equal” indicates that the equal relationship is not a strict relationship and does not exclude functionally similar variations therefrom. Unless context or the description indicates otherwise, the use of the terminology “substantially equal” in connection with two or more described dimensions indicates that the equal relationship between the dimensions includes variations that, using mathematical and industrial principles accepted in the art (e.g., rounding, measurement or other systematic errors, manufacturing tolerances, etc.), would not vary the least significant digit of the dimensions.

As is used herein, the term “substantially parallel” indicates that the parallel spatial relationship between two or more structural elements (e.g., member, traces, or the like) is not a strict relationship and does not exclude functionally similar variations therefrom. As used herein the term “substantially perpendicular” indicates that the perpendicular spatial relationship between two or more two or more structural elements (e.g., member, traces, or the like) are not a strict relationship and does not exclude functionally similar variations therefrom.

The term “horizontal” as is used herein may be defined as a direction parallel to a plane or surface (e.g., surface of a substrate), regardless of its orientation. The term “vertical,” as is used herein, may refer to a direction orthogonal to the horizontal direction as just described. Terms, such as “on,” “above,” “below,” “bottom,” “top,” “side” (as in “sidewall,” for example), “higher,” “lower,” “upper,” “over,” and “under,” may be referenced with respect to the horizontal plane.

To the extent that the term “includes” is used in either the detailed description or the claims, such term is intended to be inclusive in a manner similar to the term “comprising” as “comprising” is interpreted when employed as a transitional word in a claim. Further, conditional language, such as, among others, “can,” “could,” “might,” or “may,” unless specifically stated otherwise, or otherwise understood within the context as used, is generally intended to convey that certain example embodiments could include, while other example embodiments do not include, certain features, elements, and/or acts. Thus, such conditional language is not generally intended to imply that features, elements, and/or acts are in any way required for one or more embodiments.

Although some embodiments of the disclosure have been described in connection with what is presently considered to be the most practical, it is to be understood that this disclosure is not to be limited to the disclosed embodiments, but on the contrary, the disclosure is intended to cover various modifications and equivalent arrangements included within the scope of the claims. Although specific terms are employed herein, they are used in a generic and descriptive sense only, and not for purposes of limitation.

This written description uses examples to disclose certain example embodiments, and also to enable any person skilled in the art to practice embodiments of the disclosure, including making and using any devices or systems and performing any disclosed methods. The patentable scope of some embodiments of the disclosure is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What has been described above includes examples of one or more embodiments of the disclosure. Although example embodiments have been described in language specific to structural features and/or methodological acts, it is to be understood that the disclosure is not necessarily limited to the specific features or acts described. Rather, the specific features and acts are disclosed as illustrative forms of implementing the example embodiments. It is, of course, not possible to describe every conceivable combination of components or methodologies for purposes of describing these examples, and it can be recognized that many further combinations and permutations of the present embodiments are possible. Accordingly, the embodiments disclosed and/or claimed herein are intended to embrace all such alterations, modifications and variations that fall within the spirit and scope of the detailed description and the appended claims.

1. A touch sensor device, comprising:
an array of conductive members assembled on a first solid surface, the array comprising a first conductive member and a second conductive member adjacent to the first conductive member; and
a conductive island adjacent to the first conductive member and the second conductive member, the conductive island being capacitively coupled to a third conductive member assembled on a second solid surface opposite the first solid surface, wherein the first conductive member and the second conductive member are associated with respective sense lines, and wherein the third conductive member is associated with a drive line.

2. The touch sensor device of claim 1, wherein the conductive island is a first conductive island, and wherein the touch sensor device further comprises comprising a second conductive island adjacent to the first conductive member and the second conductive member, the second conductive island being capacitively coupled to a fourth conductive member assembled on the second surface, wherein the first solid surface is part of a printed circuit board.

3. The touch sensor device of claim 2, wherein the first conductive island and the second conductive island are adjacent to one another, and wherein a dielectric region separates the first conductive island and the second conductive island, the dielectric region including a dielectric layer.

4. The touch sensor device of claim 1, wherein the first conductive member and the second conductive member are parallel to one another, and wherein the conductive island has a first side along a first direction that is transversal to the first conductive member and the second conductive member, and further wherein the conductive island has a second side along a second direction that is parallel to the first conductive member and the second conductive member.

5. The touch sensor device of claim 4, wherein a first length of the first side ranges from about 10 mm to about 3 mm, and wherein a second length of the second side ranges from about 500 mm to about 3 mm.

6. The touch sensor device of claim 1, wherein the first solid surface pertains to a substrate, and wherein the second solid surface pertains to the substrate, the substrate comprising one of a flexible layer or a rigid layer having a uniform thickness of a magnitude within a range from about 10 mm to about 5 mm.

7. The touch sensor device of claim 1, wherein the first solid surface pertains to a first substrate, and wherein the second solid surface pertains to a second substrate, the first substrate comprising one of a first flexible layer or a first rigid layer and the second substrate comprising one of a second flexible layer or a second rigid layer.

8. The touch sensor device of claim 7, wherein the first substrate has a uniform thickness of a first magnitude within a range from about 10 mm to about 5 mm, and wherein the second substrate has a second uniform thickness of a second magnitude within a range from about 10 mm to about 5 mm.

9. The touch sensor device of claim 1, wherein the first conductive member comprises a transparent conductive oxide, and wherein the second conductive member comprises the transparent conductive oxide, and further wherein the third conductive member comprises the transparent conductive oxide.

10. The touch sensor device of claim 1, wherein the first conductive member comprises one or more carbon nanotubes, and wherein the second conductive member comprises at least one or more second carbon nanotubes, and further wherein the third conductive member comprises one or more third carbon nanotubes.

11. The touch sensor device of claim 1, wherein the first conductive member comprises a conductive polymer, and wherein the second conductive member comprises the conductive polymer, and further wherein the third conductive member comprises the conductive polymer.

12. The touch sensor device of claim 11, wherein the conductive polymer is translucent and comprises poly(3,4-ethylenedioxythiophene) polystyrene sulfonate (PEDOT:PSS).

13. A touch sensor device, comprising:
an array of conductive members assembled on a first solid surface, the array comprising a first conductive member and a second conductive member adjacent to the first conductive member;
a conductive island adjacent to the first conductive member and the second conductive member, the conductive island overlays, at a defined distance from, a third conductive member assembled on a second solid surface opposite the first solid surface, wherein the first conductive member and the second conductive member are associated with respective sense lines, and wherein the third conductive member is associated with a drive line; and
a coupling member attached to the conductive island at a first end and further attached to the third conductive member at a second end opposite the first end, wherein the third conductive member is assembled on a second solid surface opposite the first solid surface.

14. The touch sensor device of claim 13, wherein the conductive island is a first conductive island, and wherein the touch sensor device further comprises,
a second conductive island adjacent to the first conductive member and the second conductive member; and
a second coupling member coupled to the second conductive island at a first end and further coupled to a fourth conductive member at a second end opposite the first end, wherein the fourth conductive member is assembled on the second solid surface.

15. The touch sensor device of claim 14, wherein the first conductive island and the second conductive island are adjacent to one another, and wherein a dielectric region separates the first conductive island and the second conductive island.

16. The touch sensor device of claim 13, wherein the coupling member is an object of revolution about an axis that extends from the first end to the second end.

17. The touch sensor device of claim 16, wherein the object of revolution is one of a cylinder, an ellipsoid, a dome, or a sphere.

18. The touch sensor device of claim 14, wherein the coupling member has a cross-section of a defined geometry on a plane perpendicular to a line that extends from the first end to the second end, the defined geometry being one of a regular polygon, an irregular polygon, a circle, or an ellipse.

19. A display device, comprising:
a touch sensor device comprising,
an array of conductive members assembled on a first solid surface, the array comprising a first conductive member and a second conductive member adjacent to the first conductive member; and
a conductive island adjacent to the first conductive member and the second conductive member, wherein the conductive island overlays, at a defined distance from, a third conductive member assembled on a second solid surface opposite the first solid surface, wherein the first conductive member and the second conductive member are associated with respective sense lines, and wherein the third conductive member is associated with a drive line.

20. The display device of claim 19, wherein the conductive island is a first conductive island, and wherein the touch sensor device further comprises a second conductive island adjacent to the first conductive member and the second conductive member, the second conductive island being capacitively coupled to a fourth conductive member assembled on the second surface.
